(19) United States
(12) Patent Application Publication
(10) Pub. No.: US 2014/0082674 A1
(43) Pub. Date: Mar. 20, 2014

(54) APPARATUS, SYSTEM, AND METHOD FOR PROCESSING DATA

(71) Applicant: ELECTRONICS AND TELECOMMUNICATIONS RESEARCH INSTITUTE, (US)

(72) Inventors: Min Su SHIN, Daejeon (KR); Joon Gyu RYU, Daejeon (KR); Jang Hee KANG, Daejeon (KR); Deock Gil OH, Daejeon (KR)

(73) Assignee: ELECTRONICS AND TELECOMMUNICATIONS RESEARCH INSTITUTE, Daejeon (KR)

(21) Appl. No.: 13/803,464

(22) Filed: Mar. 14, 2013

(30) Foreign Application Priority Data
Sep. 20, 2012 (KR) 10-2012-0104500

(51) Int. Cl. H04N 21/61

(52) U.S. Cl. CPC H04N 21/6193
USPC 725/63

(57) ABSTRACT

Provided is a data processing apparatus and method that may initialize baseband frame data that is newly input, and may randomize the baseband frame data based on a byte unit. Also, provided is a data processing system and method that may configure baseband frame data by randomizing the baseband frame data based on the byte unit in performing mode adaptation and stream adaptation with respect to a received transport stream (TS) packet, and may perform channel encoding of the baseband frame data.

### CROSS-REFERENCE TO RELATED APPLICATION

This application claims the priority benefit of Korean Patent Application No. 10-2012-0104500, filed on Sep. 20, 2012, in the Korean Intellectual Property Office, the disclosure of which is incorporated herein by reference.

### BACKGROUND

1. Field of the Invention

Embodiments of the present invention relate to a data processing apparatus and method, and more particularly, to a baseband data processing apparatus and method for accelerating a satellite broadcasting communication system using a digital video broadcasting over satellite (DVB-S2) standard.

2. Description of the Related Art

A transmission system of a digital video broadcasting over satellite 2 (DVB-S2) standard, which is globally employed as forward-link transmission technology of a satellite communication system or a satellite broadcasting system, may receive an MPEG-2 transport stream (TS) packet, configure a baseband frame by performing a mode adaptation operation and a stream adaptation operation and then transfer the MPEG-2 TS packet to a channel encoding operation, for example, a forward error correction (FEC) encoding operation.

In the DVB-S2 standard, randomization needs to be performed with respect to the entire length of the baseband frame in order to enhance channel encoding performance, prior to shifting from the stream adaptation operation to the channel encoding operation.

A randomizer specified in the DVB-S2 standard may include 15 shift registers and two exclusive OR (XOR) processors. The 15 shift registers may be initialized to “100101010000000” every time new baseband frame data is input.

The randomizer needs to perform calculation with respect to the entire length of the baseband frame based on a bit unit and thus, may process streams that are input in series, based on the bit unit. However, in an aspect of configuring hardware, the randomizer may not achieve a processing rate greater than an operation clock. For example, in the case of configuring a scrambler to be in above structure in a field-programmable gate array (FPGA) that operates at a clock of 100 MHz, the general randomizer may not process data of maximum 100 Mbps or more.

In general, considering that a transmission modulator or a reception modulator manufactured in small quantity is configured as an FPGA and that it is not easy to drive the FPGA at a clock of 200 MHz or more, it may be difficult for a transmission and reception apparatus of the DVB-S2 standard to provide the performance of 200 Mbps or more.

In order to enhance the performance, the randomizer may be configured using a parallel processing scheme based on a baseband frame unit. However, in the case of a method of using a plurality of randomizers in a parallel structure, a memory and an internal space of the FPGA may need to be additionally used to be proportional to the number of randomizers. In addition, there is a need to accurately control input/output of each randomizer.

### SUMMARY

According to an aspect of the present invention, there is provided a data processing apparatus, including: an initializing unit to initialize baseband frame data that is newly input; and a randomizer to randomize the baseband frame data based on a byte unit.

The randomizer may obtain a pseudo random binary sequence (PRBS) value by simultaneously performing an exclusive OR (XOR) operation with respect to each of data about two adjacent bits based on the byte unit.

The randomizer may obtain a randomized output byte value by sequentially performing the XOR operation with respect to each PRBS value and a most significant bit (MSB) value to a least significant bit (LSB) value of the baseband frame data.

The randomizer may update each PRBS value by inputting each PRBS value at a position of a bit corresponding to a shift register.

The randomizer may shift before-update data of the bit corresponding to the shift register and thereby replace an un-updated bit with the before-update data.

According to another aspect of the present invention, there is provided a data processing system, including: a receiver to receive a transport stream (TS) packet; a data configuring unit to configure baseband frame data by performing mode adaption and stream adaptation with respect to the TS packet; and an encoder to perform channel encoding of the baseband frame data. The data configuring unit may randomize the baseband frame data based on a byte unit.

According to still another aspect of the present invention, there is provided a data processing method, including: initializing baseband frame data that is newly input; and randomizing the baseband frame data based on a byte unit.

According to yet another aspect of the present invention, there is provided a data processing method, including: receiving a TS packet; configuring baseband frame data by performing mode adaption and stream adaptation with respect to the TS packet; and performing channel encoding of the baseband frame data. The configuring may include randomizing the baseband frame data based on a byte unit.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a data processing system applicable with a data processing apparatus according to an embodiment of the present invention;

FIG. 2 is a block diagram illustrating a configuration of a data processing apparatus according to an embodiment of the present invention;

FIG. 3 is a diagram illustrating an example of processing a bit-unit scrambler based on a byte unit of eight bits according to an embodiment of the present invention;

FIG. 4 is a block diagram illustrating a data processing system according to an embodiment of the present invention;

FIG. 5 is a flowchart illustrating a data processing method according to an embodiment of the present invention;

FIG. 6 is a flowchart illustrating a method of randomizing baseband frame data based on a byte unit using a data processing apparatus according to an embodiment of the present invention; and

FIG. 7 is a flowchart illustrating a data processing method according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

A data processing apparatus according to an embodiment of the present invention may be applied to a data processing system of a digital video broadcasting over satellite 2 (DVB-S2) standard, which is employed as forward-link transmission technology of a satellite communication system or a satellite broadcasting system.

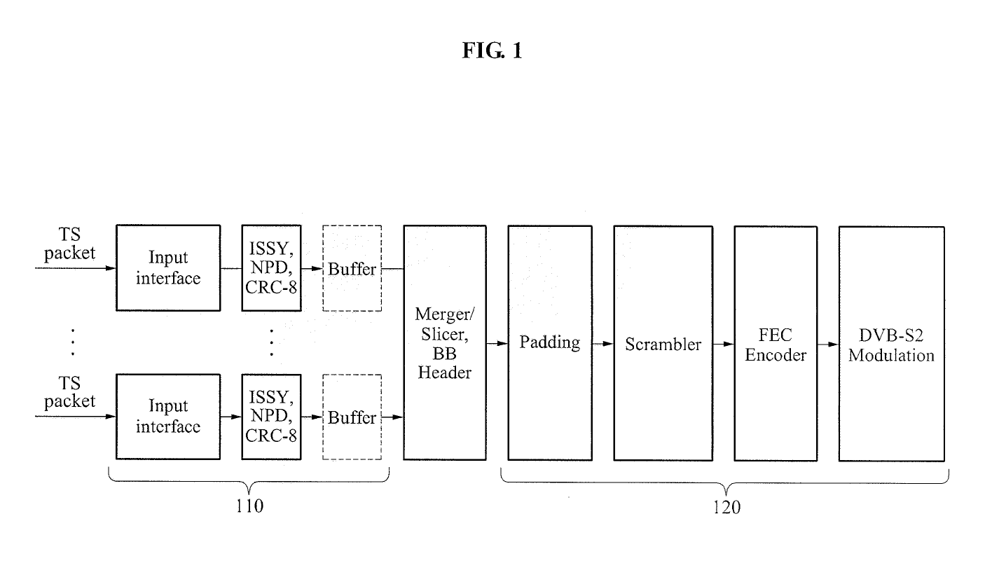

FIG. 1 is a block diagram illustrating a configuration of a data processing system applicable with a data processing apparatus according to an embodiment of the present invention.

Referring to FIG. 1, in a DVB-S2 standard, a unit input stream or multi-input stream may be received and be processed. In a broadcasting application field, an MPEG-2 transport stream (TS) packet may be used as an input data format and a DVB via asynchronous serial interface (DVB-ASI) may be used as a physical interface.

In an aspect of an actual data transmission rate, a single ASI interface may transmit data at a maximum of 216 Mbps. In the case of using multiple input interfaces, a data rate for processing internal functional blocks may be more than or equal to a giga level.

A function may be configured for each unit with respect to blocks 110, starting with input interfaces and continuing up to blocks before a merger/slicer baseband (BB) header block that constitutes a data field of a baseband frame. The blocks 110 may require only data processing performance corresponding to a maximum of 216 Mbps. Also, blocks 120 starting after the merger/slicer BB header block may require high processing performance that is proportional to a total number of input interfaces.

A scrambler may support the entire input data rate of the multiple input interfaces, and may simultaneously perform a randomization process with respect to a plurality of baseband frames through a parallel structure.

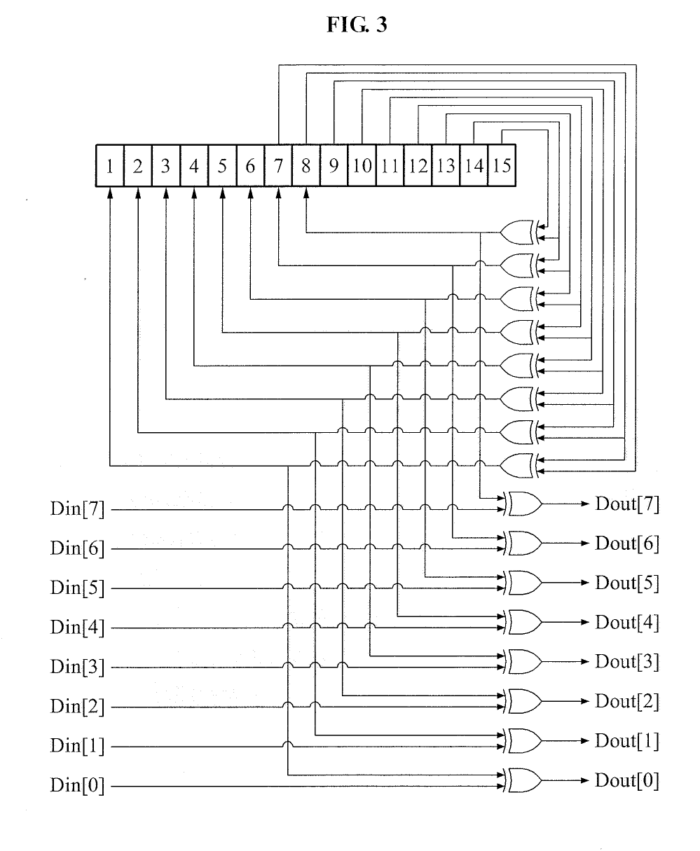

According to an embodiment of the present invention, a scrambler specified in the DVB-S2 standard may use 15 bits of a shift register (hereinafter, REG[15:1]). As illustrated in FIG. 3, when new baseband frame data is input, the scrambler may initialize the shift register to a predetermined value, for example, “100101010000000”.

When a new baseband frame is input, the data processing apparatus may obtain a pseudo random binary sequence (PRBS) value by performing an exclusive OR (XOR) operation with respect to fourteenth and fifteenth register values, and may shift all of the register values to the right by each single bit, by inputting the PRBS value into the first register again.

The data processing apparatus may output one-bit randomized data by performing the XOR operation with respect to the PRBS value and a most significant bit (MSB) value of the baseband frame data.

Even though the data processing apparatus may configure the scrambler through the parallel structure, there may be provided a data processing apparatus and method that may configure the scramble to be operable based on a byte unit.

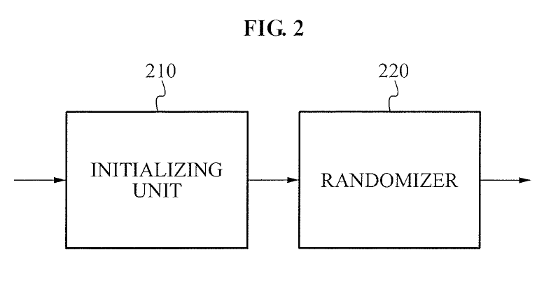

FIG. 2 is a block diagram illustrating a configuration of a data processing apparatus according to an embodiment of the present invention.

Referring to FIG. 2, the data processing apparatus may include an initializing unit 210 to initialize baseband frame data that is newly input and a randomizer 220 to randomize the baseband frame data based on a byte unit.

FIG. 3 is a diagram illustrating an example of processing a bit-unit scrambler based on a byte unit of eight bits according to an embodiment of the present invention.

Referring to FIG. 2 and FIG. 3, the randomizer 220 may obtain a PRBS value by simultaneously performing an XOR operation with respect to each of data about two adjacent bits based on the byte unit. For example, to generate a PRBS value to be applied to 8-bit input data Din[7:0] in a single clock, the randomizer 220 may perform the XOR operation at a time with respect to REG[15:14], REG[14:13], REG[13:12], REG[12:11], REG[11:10], REG[10:9], REG[9:8], and REG[8:7].

The randomizer 220 may obtain a randomized output byte value by sequentially performing the XOR operation with respect to each PRBS value and an MSB value to a least significant bit (LSB) value of the baseband frame data. For example, the randomizer 220 may obtain a randomized byte value Dout[7:0] by sequentially performing an XOR operation with respect to each PRBS value and an MSB value to an LSB value of an input byte.

The randomizer 220 may update each PRBS value by inputting each PRBS value at a position of a bit corresponding to a shift register. For example, as illustrated in FIG. 3, the randomizer 220 may update each PRBS value by obtaining an output byte value and at the same time, inputting each PRBS value at a corresponding position of a shift register.

The randomizer 220 may shift before-update data of the bit corresponding to the shift register and thereby replace an un-updated bit with the before-update data. For example, the randomizer 220 may shift before-update REG[1:7] and thereby replace remaining REG[9:15] with the shifted before-update REG[1:7].

Hereinafter, a data processing system of a DVB-S2 scheme including a data processing apparatus according to an embodiment of the present invention will be described.

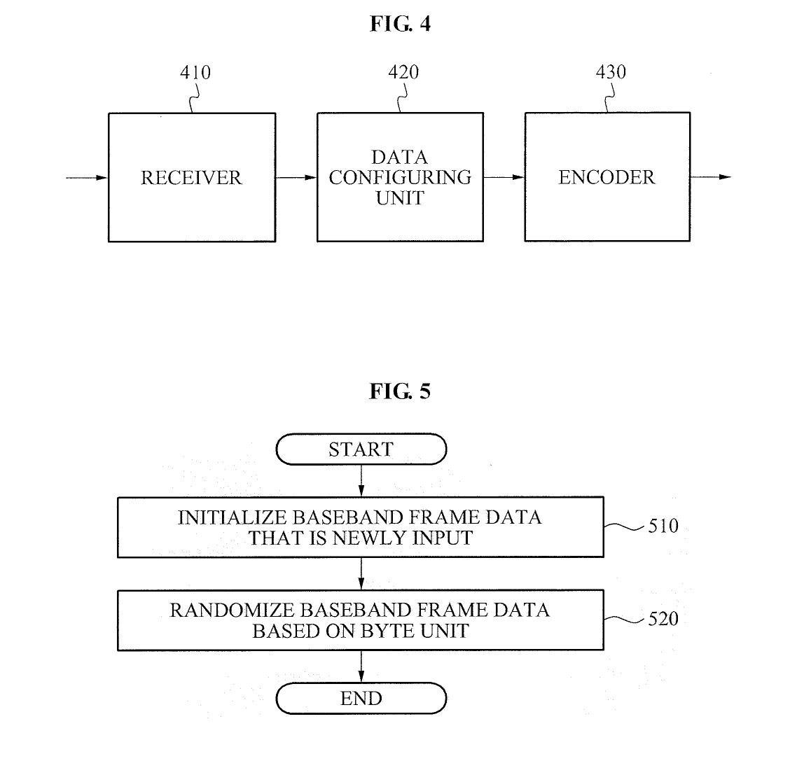

FIG. 4 is a block diagram illustrating a data processing system according to an embodiment of the present invention.

Referring to FIG. 4, the data processing system may include a receiver 410 to receive a TS packet, a data configuring unit 420 to configure baseband frame data by performing mode adaption and stream adaptation with respect to the TS packet, and an encoder 430 to perform channel encoding of the baseband frame data. The data configuring unit 420 may randomize the baseband frame data based on a byte unit.

The data configuring unit 420 may perform all of the operational functions of the aforementioned data processing apparatus and thus, may perform the following data processing operation.

The data configuring unit 420 may obtain a PRBS value by simultaneously performing an XOR operation with respect to each of data about two adjacent bits based on the byte unit. The data configuring unit 420 may obtain a randomized output byte value by sequentially performing the XOR operation with respect to each PRBS value and an MSB value to an LSB value of the baseband frame data.

The data configuring unit 420 may update each PRBS value by inputting each PRBS value at a position of a bit corresponding to a shift register. The data configuring unit 420 may shift before-update data of the bit corresponding to the shift register and thereby replace an un-updated bit with the before-update data.

Hereinafter, a method of processing baseband frame data based on a byte unit using a data processing apparatus according to an embodiment of the present invention will be described.

FIG. 5 is a flowchart illustrating a data processing method according to an embodiment of the present invention.

Referring to FIG. 5, a data processing apparatus according to an embodiment of the present invention may initialize baseband frame data that is newly input in operation 510, and may randomize the baseband frame data based on a byte unit in operation 520.

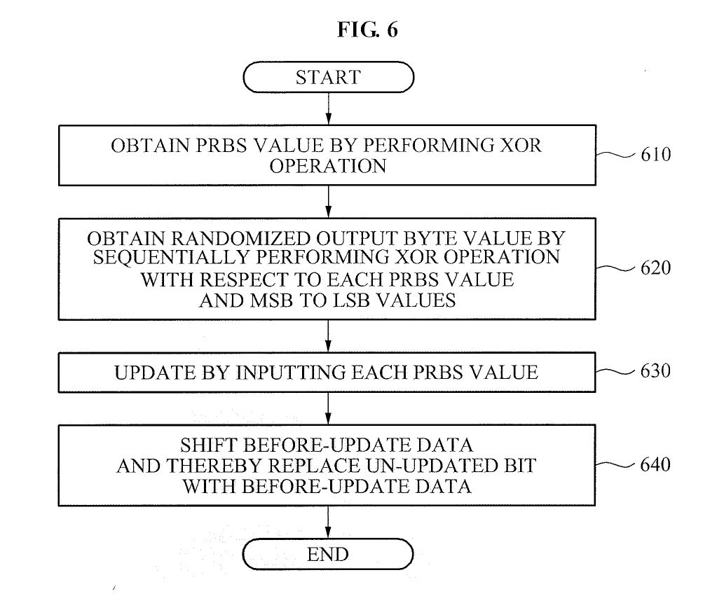

FIG. 6 is a flowchart illustrating a method of randomizing baseband frame data based on a byte unit using a data processing apparatus according to an embodiment of the present invention.

Referring to FIG. 6, a data processing apparatus according to an embodiment of the present invention may obtain a PRBS value by simultaneously performing an XOR operation with respect to each of data about two adjacent bits based on a byte unit in operation 610. In operation 620, the data processing apparatus may obtain a randomized output byte value by sequentially performing the XOR operation with respect to each PRBS value and an MSB value to an LSB value of the baseband frame data.

In operation 630, the data processing apparatus may update each PRBS value by inputting each PRBS value at a position of a bit corresponding to a shift register. In operation 640, the data processing apparatus may shift before-update data of the bit corresponding to the shift register and thereby replace an un-updated bit with the before-update data.

Hereinafter, a method of processing baseband frame data based on a byte unit using a data processing system according to an embodiment of the present invention will be described.

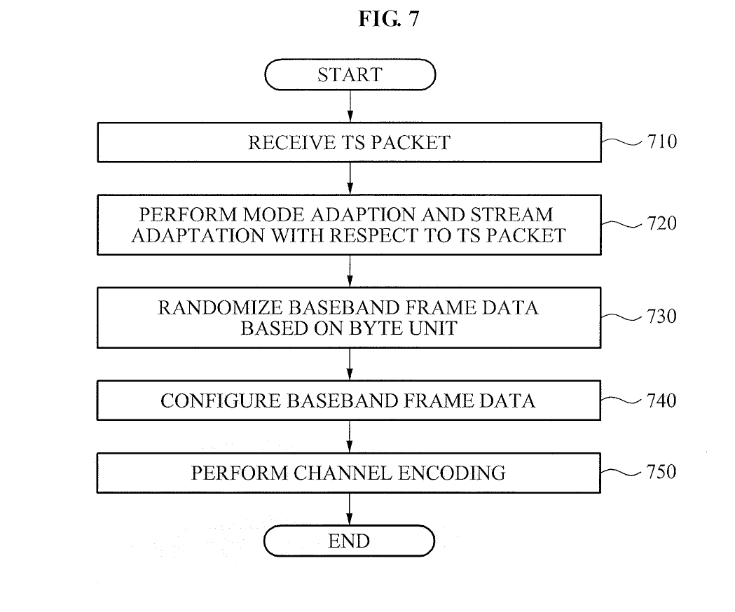

FIG. 7 is a flowchart illustrating a data processing method according to another embodiment of the present invention.

Referring to FIG. 7, the data processing system may receive a TS packet in operation 710, and may perform mode adaption and stream adaptation with respect to the TS packet in operation 720.

In operation 730, the data processing system may randomize the baseband frame data based on the byte unit. In operation 740, the data processing apparatus may configure baseband frame data. In operation 750, the data processing system may perform channel encoding of the baseband frame data.

A data processing apparatus and system according to an embodiment of the present invention may enhance a data processing rate by processing data based on a byte unit in a scrambler, and may exhibit data processing capability required to transmit data at an ultra high rate through a wideband satellite repeater.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A data processing apparatus, comprising:
an initializing unit to initialize baseband frame data that is newly input; and
a randomizer to randomize the baseband frame data based on a byte unit.

2. The data processing apparatus of claim 1, wherein the randomizer obtains a pseudo random binary sequence (PRBS) value by simultaneously performing an exclusive OR (XOR) operation with respect to each of data about two adjacent bits based on the byte unit.

3. The data processing apparatus of claim 2, wherein the randomizer obtains a randomized output byte value by sequentially performing the XOR operation with respect to each PRBS value and a most significant bit (MSB) value to a least significant bit (LSB) value of the baseband frame data.

4. The data processing apparatus of claim 2, wherein the randomizer updates each PRBS value by inputting each PRBS value at a position of a bit corresponding to a shift register.

5. The data processing apparatus of claim 4, wherein the randomizer shifts before-update data of the bit corresponding to the shift register and thereby replaces an un-updated bit with the before-update data.

6. A data processing system, comprising:
a receiver to receive a transport stream (TS) packet;
a data configuring unit to configure baseband frame data by performing mode adaption and stream adaptation with respect to the TS packet; and
an encoder to perform channel encoding of the baseband frame data,
wherein the data configuring unit randomizes the baseband frame data based on a byte unit.

7. The data processing system of claim 6, wherein the data configuring unit obtains a pseudo random binary sequence (PRBS) value by simultaneously performing an exclusive (XOR) operation with respect to each of data about two adjacent bits based on the byte unit.

8. The data processing system of claim 7, wherein the data configuring unit obtains a randomized output byte value by sequentially performing the XOR operation with respect to each PRBS value and a most significant bit (MSB) value to a least significant bit (LSB) value of the baseband frame data.

9. The data processing system of claim 7, wherein the data configuring unit updates each PRBS value by inputting each PRBS value at a position of a bit corresponding to a shift register.

10. The data processing system of claim 9, wherein the data configuring unit shifts before-update data of the bit corresponding to the shift register and thereby replaces an un-updated bit with the before-update data.

11. A data processing method, comprising:
initializing baseband frame data that is newly input; and
randomizing the baseband frame data based on a byte unit.

12. The method of claim 11, wherein the randomizing comprises obtaining a pseudo random binary sequence (PRBS) value by simultaneously performing an exclusive OR (XOR) operation with respect to each of two adjacent bits based on the byte unit.

13. The method of claim 12, wherein the randomizing further comprises obtaining a randomized output byte value by sequentially performing the XOR operation with respect to each PRBS value and a most significant bit (MSB) value to a least significant bit (LSB) value of the baseband frame data.

14. The method of claim 12, wherein the randomizing further comprises updating each PRBS value by inputting each PRBS value at a position of a bit corresponding to a shift register.

15. The method of claim 14, wherein the randomizing further comprises shifting before-update data of the bit corresponding to the shift register and thereby replacing an un-updated bit with the before-update data.

16. A data processing method, comprising:
receiving a transport stream (TS) packet;
configuring baseband frame data by performing mode adaption and stream adaptation with respect to the TS packet; and
performing channel encoding of the baseband frame data,
wherein the configuring comprises randomizing the baseband frame data based on a byte unit.

17. The method of claim 16, wherein the randomizing comprises obtaining a pseudo random binary sequence (PRBS) value by simultaneously performing an exclusive OR (XOR) operation with respect to each of two adjacent bits based on the byte unit.

18. The method of claim 17, wherein the randomizing further comprises obtaining a randomized output byte value by sequentially performing the XOR operation with respect to each PRBS value and a most significant bit (MSB) value to a least significant bit (LSB) value of the baseband frame data.

19. The method of claim 17, wherein the randomizing further comprises updating each PRBS value by inputting each PRBS value at a position of a bit corresponding to a shift register.

20. The method of claim 19, wherein the randomizing further comprises shifting before-update data of the bit corresponding to the shift register and thereby replacing an un-updated bit with the before-update data.
